(19) United States
(12) Patent Application Publication
(10) Pub. No.: US 2013/0132823 A1
(43) Pub. Date: May 23, 2013

(54) METADATA AUGMENTATION OF WEB PAGES

(71) Applicant: InspiredLabs Ltd., London (GB)

(72) Inventor: Leo Kristofer Set Sutic, London (GB)

(73) Assignee: INSPIREDLABS LTD., London (GB)

(21) Appl. No.: 13/678,677

(22) Filed: Nov. 16, 2012

(30) Foreign Application Priority Data
Nov. 21, 2011 (GB) 1120072.2

(51) Int. Cl. G06F 17/21

(52) U.S. Cl. CPC G06F 17/218
USPC 715/234

(57) ABSTRACT

A method of metadata augmentation of web pages may include the steps of generating a URL relating to embedded media in a first web page, wherein the URL is for a metadata page separate to the first web page, and providing the metadata page with metadata tags indicating viewing settings and/or parameters for the embedded media along with a redirect to the first web page. When the URL is shared on third party web page the third party web page will extract metadata from the metadata page and display the embedded media in accordance with the viewing settings and/or parameters, and a user following the URL will be redirected to the first web page.

### TECHNICAL FIELD

The present invention relates to a method of metadata augmentation of web pages, a rich media viewer, and a corresponding computer program product.

### BACKGROUND OF THE INVENTION

The World-Wide Web, commonly referred to simply as “The web” consists roughly of units called “pages”. The pages can be accessed via the Internet, generally by means of a web address in the form of a Uniform Resource Locator or Universal Resource Locator (URL), which can be input into a web browser or accessed via link. Each web page can contain text, formatting, images and links to other pages. All of this information exists in a format called HTML, or HyperText Markup Language. “HyperText” refers to text displayed on a computer or other electronic device with references (hyperlinks) to other text that the reader can immediately access. The hyperlinks are generally access via a mouse click or keypress sequence. “Markup Language” refers to the fact that that any information that isn't readable text exists as “markup” or in colloquial terms, “tags”.

By way of a simple example, information about which words should be bolded exists as markup. The text:

The last word is bold.

would be written in HTML as

The last word is <b>bold</b>.

Where the “<b>” and “</b>” are markup denoting that anything between the opening tag (<b>) and the closing tag (</b>) should be displayed in boldface.

Not all information that exists as markup is related to formatting. The <title> tag denotes that the text between the opening and closing tag should be used to display a title text in the web browser window's title area. In case of multiple titles in a page, the web browser will either produce an error message or try to resolve the conflict in some way

In addition to these kinds of information, there is a need to have information about the page itself in order to have services—such as search engines—that operate on pages. For example: Should this page be indexed by search engines? What is a concise description of the page? Who wrote this page?

When the Web was initially developed, the question then was whether this information, called “metadata”, should be in the page, or stored somewhere else—perhaps in a big, government run database. The choice was to include the information in the HTML code. The reasoning for this was that if information about the page and the page itself are kept close, then there is no need for a huge, expensive, always-available central database and associated customer support services; and the metadata is more likely to be updated with the page.

The way metadata is included is via <meta>, <link> and other tags. As an example, here follows metadata that tells a search engine that this page should be associated with the latitude/longitude 59.17/18.25 (Tyresta National Park, southeast of Stockholm):

<meta name=“geo.position” content=“59.17; 18.25”/>

This information can be used to “place” a page or entire website at a real-world location.

An example of when this is useful is when the page is about a restaurant—include the lat/long information, and a person reading the web page could quickly see exactly where the restaurant is and perhaps even get directions there if their web browser is sophisticated enough. The whole setup works because the web browser knows that a <meta> tag with the name “geo .position” means that the content will contain a lat/long position.

In the same way, a concise description of the page is found in the content of a <meta> tag with the name “description”:

<meta name=“description”
content=“An easy to understand guide about metadata.”/>

This system, where a page owner can easily add any kind of metadata to their pages is very extensible, as no central authority needs to approve the metadata type and format before it is used. Instead, anyone is free to create a metadata specification, and anyone is free to implement it. Some specifications are drawn up by industry-wide workgroups, but it is also possible for individuals or companies to essentially state that “our product looks for the following metadata. Implement it if you want to integrate with us.” If the product is compelling enough, web developers will find it worthwhile to implement the metadata scheme.

Facebook™ is one of the companies that have specified a metadata scheme. Their scheme is called Open Graph, and it allows the web page author to specify, among other things, how links to the page will appear in the Facebook™ news feed when users share the page. An example of the different parts of the appearance of the page that can be controlled is discussed below with reference to FIG. 1, which shows a portion of a Facebook™ web page.

That appearance of the web page can be controlled in the following ways:

1. The title of the link, using a <title> tag.

2. The summary text, using a <meta name=“description”> tag.

3. The small icon to the left of the link, using a <link rel=“image_src”> tag.

4. The ability to add rich media that can be activated by the user. In conventional usage of Open Graph this can be an embedded video, for example. This is done with a <meta property=“og : video”> tag.

A problem arises since the majority of web pages will be owned and operated by companies or individuals that are not interested in implementing complex metadata management systems. The web page owner will wish to take advantage of the benefits of embedding a media viewer, but will not implement a bespoke arrangement of metadata on their web page to manage the embedded content. In the cases where the web page owner does implement metadata, they may not update the system to provide the most up-to-date version of the metadata. For example, if the rich media is offered in several formats, all formats must be listed in the metadata. If a new format is added, all pages that serve metadata must be updated to include the new format. It is therefore desirable to partially decouple the metadata from the web page.

### SUMMARY OF THE INVENTION

Viewed from a first aspect, the invention provides a method of metadata augmentation of web pages comprising: generating a URL relating to embedded media in a first web page, wherein the URL is for a metadata page separate to the first web page; and providing the metadata page with metadata tags indicating viewing settings and/or parameters for the embedded media along with a redirect to the first web page; whereby when the URL is shared on third party web page the third party web page will extract metadata from the metadata page and display the embedded media in accordance with the viewing settings and/or parameters, and a user following the URL will be redirected to the first web page.

With this method it is possible to control the metadata content that is extracted by a third party web page such as Facebook™ or other social networking and media sharing web pages without the need for the first web page to include any specially adapted metadata. The metadata page controls what is shown on the third party website and hence allows this content to be controlled in order to best display the embedded media. The redirect means that the user will be taken to the web page of interest as usual, when they attempt to follow links on the third party web page.

In a preferred embodiment, the redirect is itself augmented by metadata, for example in order that the user is redirected to the first web page with the embedded media viewable in accordance with redirect viewing settings and/or parameters. This further improves the user experience and promotes best use of the embedded media.

The embedded media may comprise video, interactive images and/or video, Flash animation, maps, Booking facilities, chat and/or email engagement facilities, email share, bitly share, Facebook share, twitter share g+ share or similar. The embedded media may comprise an interactive view of one or more of a building exterior and/or interior, a streetscape, a landscape, an object or a product.

In a preferred embodiment the viewing settings and/or parameters comprise one or more of: a start point for interactive media, a video or a slideshow; a viewing angle, which may include pitch and/or yaw; a zoom level relating to an interactive image or video, or any other parameter that defines a location, position, viewpoint or the like in time or in space within the embedded media. With the use of viewing settings and/or parameters of this type the metadata can direct the third party website to display the embedded media in a specific fashion, for example at a particular point in a video or with a specific viewpoint in a virtual tour, such as a virtual tour of a building.

Preferably, the viewing settings and/or parameters are determined based on the parameters of the embedded media at the time the URL is generated. Thus, the viewing settings and/or parameters can reflect the state of the embedded media as it is being viewed, and enable the user to share the embedded media with others so that they can see the embedded media in the same state as the original user of the first web page.

The redirect could be set to direct the user of the third party web page to the first web page such that it is viewable in a different manner to that defined by the viewing settings and/or parameters of the metadata tags. However, preferably the redirect is configured to direct the user to the first web page with viewing settings and/or parameters as defined in the metadata and hence the redirect viewing settings and/or parameters are preferably the same as the viewing settings and/or parameters of the metadata tags. As discussed above, these viewing settings and/or parameters may be based on parameters of the embedded media at the time that the URL is generated.

In a preferred embodiment, the first web page comprises a media viewer for displaying the embedded media, and preferably this viewer generates the URL. This arrangement means that the viewer sets the URL for the metadata page and hence can control the way in which the embedded media is displayed at the third party web page and linked to from the third party web page.

The viewer may be for showing any media type as discussed above, including, in a preferred embodiment, a media viewer for providing an interactive tour of a building or product, in which the building or product can be viewed from multiple positions.

The method may include an entity associated with the media viewer carrying out the step of providing the metadata page. Hence, this entity may define the metadata tags and the redirect. The entity may for example be the owner or programmer of the media viewer, or a web service company operating the media viewer. In this way there is no requirement for the owner of the first web page to have any involvement with the metadata web page, and no additional effort is required on their part to take advantage of the capabilities of the media viewer, which may require a particular set of metadata tags.

The metadata page may be provided with metadata tags from a metadata database. The use of a database, preferably a central database, means that updates can be provided without the need to update a large number of separate metadata web pages.

In one preferred embodiment the redirect is a JavaScript™ redirect. This feature is particularly useful when the third party web page is Facebook™, or other similar systems, since if an HTTP redirect is used then Facebook™ will follow it directly and will fetch metadata relating to the first web page rather than metadata from the metadata page.

The metadata web page may include user-agent detection, whereby the third party web page is presented with the metadata tags and the user is presented with the redirect. This can permit the use of any type of redirect including HTTP since crawler type agents, such as Facebook™ will not see the redirect. Preferably the user agent detection is arranged to present known crawler type agents with the metadata tags while other agents, which are assumed to be web browsers, are presented with the redirect.

Viewed from a second aspect, the invention provides a metadata augmentation apparatus for web pages, the apparatus comprising a URL generator for generating a URL relating to embedded media in a first web page, wherein the URL is for a metadata page separate to the first web page; and a metadata page generator for providing the metadata page, the metadata page including with metadata tags indicating viewing settings and/or parameters for the embedded media along with a redirect to the first web page; whereby when the URL is shared on third party web page the third party web page will extract metadata from the metadata page and display the embedded media in accordance with the viewing settings and/or parameters, and a user following the URL will be redirected to the first web page.

The apparatus may for example comprise one or more data processing devices running computer code that configures them to operate as the URL generator and metadata page generator.

The embedded media may be as discussed above in relation to the first aspect. Similarly, the viewing settings and/or parameters and the redirect may be as discussed above. In particular, the redirect may be augmented by metadata, for example in order that the user is redirected to the first web page with the embedded media viewable in a manner defined by the metadata page and/or the URL. For certain sites, such as social sites, the redirect may have the result that the media is served into those sites.

In a preferred embodiment the apparatus comprises a viewer for displaying the embedded media, and preferably this viewer is the URL generator. The viewer may be a computer implemented device and may be for showing any media type as discussed above, including, in a preferred embodiment, a media viewer for providing an interactive tour of a building or product, in which the building or product can be viewed from multiple positions.

The apparatus may include a metadata database, which is preferably in communication with the metadata page generator and may be a part thereof.

Viewed from a third aspect the invention provides a computer program product comprising instructions that when executed on a data processing device will configure the device to carry out the above described method of metadata augmentation of web pages.

### BRIEF DESCRIPTION OF THE DRAWINGS

Certain preferred embodiments of the invention will now be described by way of example only and with reference to the accompanying drawings, in which:

FIG. 1 shows a portion of a typical Facebook™ web page; FIG. 2 illustrates a conventional set-up for sharing a web page on a social media site such as Facebook™;

FIG. 3 is an example of posting of a URL for a web page with embedded rich media as an update on a Facebook™ web page;

FIG. 4 shows the conventional action of navigating from the social media site to the shared URL of FIG. 3;

FIG. 5 shows an embodiment with metadata augmentation of the web page;

FIG. 6 illustrates the change in the sharing process; and

FIG. 7 shows the corresponding change when the user navigates from the social media site to the URL with metadata augmentation.

### DETAILED DESCRIPTION

It is common to wish to embed rich media such as video and interactive media into web pages. A media viewer is used to display the embedded content. As used herein, the term “media viewer” is intended to encompass viewers and players for all types of content, including video, interactive images and/or video, Flash animation, maps, Booking facilities, chat and/or email engagement facilities, email share, bitly share, Facebook share, twitter share g+share or similar. A preferred embodiment for metadata augmentation of web pages will be described herein in the context of media shared via a social media site, which in this example is Facebook™. It will however be appreciated that this technique applies more broadly and can be used with any system incorporating embedded rich media elements into a web page where it is desirable to improve sharing of the rich media. It is highly desirable to have integration with rich media in order to improve ease of access to the rich media and to improve the appearance and utility of web pages. Embedded rich media enhances the appearance and functionality of a web page. In addition the threshold for a user to activate rich media embedded in a web page, such as in the Facebook™ news feed, is much lower than the threshold for the same user to follow a link out of the web page to another web site.

As explained above, in the Open Graph metadata scheme rich media can be embedded into a Facebook™ web page and for video this is done with a <meta property=“og:video”> tag. Including additional content into the rich links on depends on being able to place the appropriate metadata tags in the web page that is being shared, which would typically be a web page including an embedded media viewer. No metadata tags mean no rich media. Typically, the creator of the web page will be reluctant to add metadata tags in any non-standard fashion. Suppliers of media viewers can provide complex capabilities that might greatly improve the web page. In the prior art, if the owner of the web page does not add appropriate metadata then the web page is not able to take advantage of these capabilities.

Hence, it is highly advantageous for the media viewer to aid in metadata augmentation of the web page. The method and media viewer described herein allows control of the metadata that is presented to hosting sites such as Facebook™ when they link to a web page incorporating the media viewer as embedded content. This does not require any extra effort for the web page owner and nor does it require access to their website.

In order to understand the invention it is instructive to first consider how the link sharing and metadata retrieval process works for Facebook™.

The process starts when the user types or pastes a URL into the “Update Status” box on Facebook™. As illustrated in FIG. 2, Facebook™ immediately fetches the page, which is then analyzed and metadata is extracted in accordance with the Open Graph system:

<title>Inspired Labs</title>
<meta name=“description”
content=“InspiredLabs has developed . . . ”>
<link rel=“image_src” href=“ . . . ”>
. . .

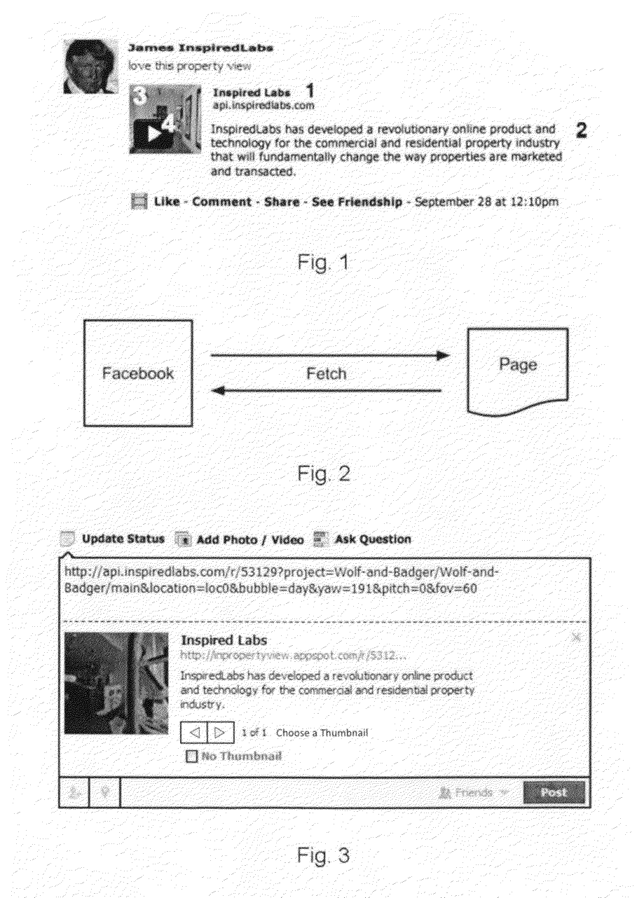

The extracted metadata is used to create the link snippet that is presented to others looking at the shared link on the Facebook™ page, as shown in FIG. 3. This contains various different features as discussed above in relation to FIG. 1. When the web page is viewed the user can click on the rich media to activate it, for example in order to play a video, or they can click on the hyperlink to navigate away from Facebook™ to the linked content.

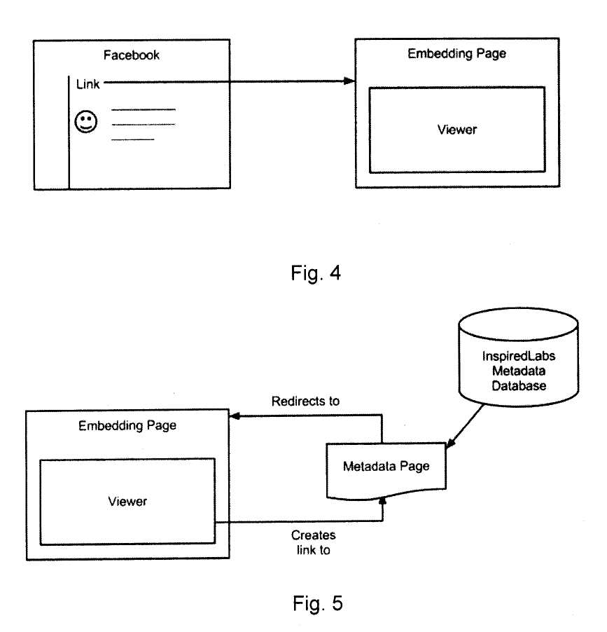

The page that is fetched and analysed is the page pointed to by the URL that is pasted in. Conventionally this will simply be the URL for the web page that contained the original embedded content. The standard metadata scheme will create a link that points to the original URL, and therefore using the hyperlink will direct the user back to the page that the media viewer appears in, as shown in FIG. 4.

In the current system, a significant change is made. The media viewer, which is a 3D viewer in this embodiment, creates a URL for sharing, and this URL points to a metadata page that is separate to the web page. The 3D viewer allows the user to move around in a 3D space and create bookmarks that lead back to the page the viewer is embedded in, and moreover, leads back to the page in such a way as to start the viewing experience in the same position and orientation that the 3D viewer had when the bookmark was created. A preferred embodiment involves using the 3D viewer to view properties, for example via a property agent's web page. When a user views an apartment on a property agent's website and creates a bookmark in the viewer that is then shared on Facebook^{TM}, or in a similar manner via an alternative website, then any person clicking on the link will:

(1) end up on the property agent's page, and

(2) the viewer on the page will start looking at the same object as it was when the bookmark was created.

Users can therefore create bookmarks that allow others to look not only at a property, but at specific parts of it. The URLs created by the media viewer are essentially set to the specification of the user based on what they are viewing at the time they create the bookmark.

An important feature of this new technique is that while the media viewer does not control the page the viewer is embedded in, it can control all the URLs being created. The opportunity is then to create a different URL and use that to insert a page with Facebook™ type metadata in the process.

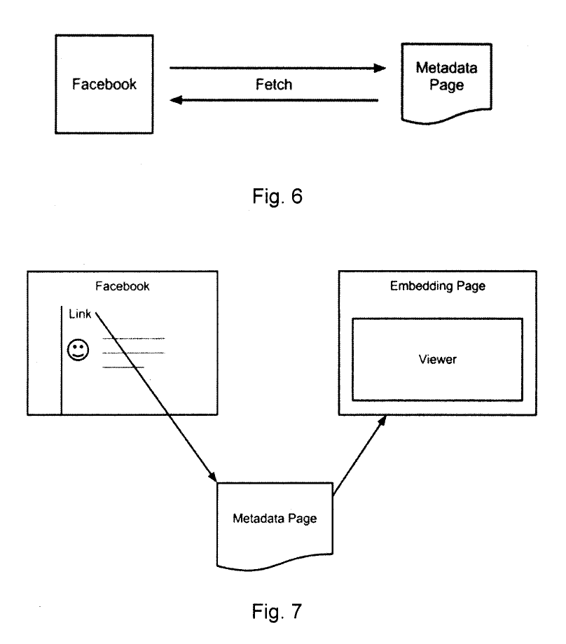

As noted above, when the URL is created in place of the conventional link to the embedding web page, which would have the result shown in FIG. 4, the media viewer instead creates a link to a metadata page, that, when visited, redirects the user to the embedding page. This is shown in FIG. 5. Since the metadata page can be controlled independently of the embedded webpage then it can be populated with metadata tags defined separately based on the capabilities of the media viewer. In practice, the metadata page can be operated by the supplier if the media viewer, or a separate web service provider, with metadata being input from the operator's metadata database. Since it is the link to the metadata page that is shared on Facebook™ then it is the page that Facebook™ fetches as shown in FIG. 6. In place of analysing metadata from the embedded web page, which is the result of the conventional fetching operation of FIG. 2, Facebook™ will analyse metadata from this metadata page. It is this augmented metadata that is used to create the link snippet, which hence will be different to the conventional link snippet. The link snippet may appear the same, as in FIG. 1, but when the user clicks through, they end up at the metadata page. Since this page redirects them to the original embedding page, as shown in FIG. 7, the user will most likely never know that the metadata page exists.

The end result is that the linking process works in an improved manner. The media viewer creates a URL to a metadata web page that includes metadata controlled and augmented by the operator of the media viewer, which hence offers more control in the information shown in the Facebook™ snippet. The outward URL takes the user to the original web page, via redirection from the metadata page, but with the enhancement that it can set a desired position or location as a start point within the embedded media because the metadata within the metadata page is under the control of the media viewer operator. This does not require any additional effort or skill from the owner or operator of the original web page with the embedded media, and hence they can take advantages of additional capabilities of the media viewer without the need for any change to their own web site.

An important feature to note in relation to the exemplary implementation for Facebook™ (and all similar systems) is that the redirect within the metadata page is a JavaScript™ redirect, rather than an HTTP redirect. The reason for the use of this feature is that Facebook™ will follow an HTTP redirect directly, and would hence not fetch the metadata page. Hence, the preferred embodiment avoids presenting a HTTP redirect to Facebook™ or other similar third party web pages. An alternative to the use of a JavaScript™ redirect is to make use of user agent detection based on the “User Agent” header from the requester. Known crawler type agents such as Facebook™ can be detected and then presented with the metadata tags. Other agents, which are assumed to be web-browsers, will be presented with the redirect. In this case the redirect can be a HTTP redirect, since the crawler type agent will not see it.

Although the embodiment above involves a media player for displaying interactive images for a property agent's website, the metadata augmentation technique also applies to other fields, and can be implemented for any embedded media viewer in order to augment any web page that includes the embedded page element with any kind of metadata when links to the web page are created by the embedded element.

For example: When embedding a video on a blog, the link that is created from within the video player should:

(1) point back to the blog and

(2) still have the current set of metadata that allows shared videos to be played directly in the news feed.

With the method described above, this can be done without access to the blog page.

In addition, although the discussion herein focuses on Facebook™ and on Open Graph metadata this is an example only and the invention is not limited to this implementation.

A specific example will now be set out in the context of a URL using metadata tags for the Open Graph metadata scheme. In will of course be appreciated that this can be adapted for other metadata schemes without undue effort.

Database Schema

The database schema consists of a single data type:

EmbedSettings {
/**
* The unique metadata set id, an 64-bit integer.
*/
long id;
/**
* Default object to embed, unless other specified.
*/
String clientAccount;
String object;
/**
* URL of the embedding page. This is the base URL
* we redirect to.
*/
String target;
/**
* In-feed viewer parameters. The parameters are
* specified elsewhere and here we simply deal
* with them as a String->Object map (that is,
* a list of names and corresponding values of
* any type.)
*/
Map<String,Object> embedParameters;
}

Metadata Page Generation

The process is split into two stages, each of which can be customized for the platform the media viewer is hosted on:

1. Getting the appropriate metadata set from the database

2. Rendering the metadata page

In this discussion we will use a sample bookmark URL, whose parts will be explained below:

http://api.inspiredlabs.com/r/53129?collection=InspiredLabs/
TheArchWhole&project=Rafi/The-Arch/
main&location=loclobby14&bubble=day&yaw=0&pitch=0&fov=60

The bookmark URL need not be formatted this way - see the section “Other Bookmark URL Formats” below—but it needs to have the same information as the sample URL.

Retrieving Metadata from Database

The metadata is stored under a unique key. That key is passed in via the bookmark URL and is used to fetch the correct EmbedSettings record. In the example URL, this is 53129:

http://api.inspiredlabs.com/r/53129?collection=. . .

The record is fetched and the parameters read from it:

| | |
|---|---|
| id | 53129 |
| clientAccount | Rafi |
| object | The-Arch |
| target | http://inspiredlabs.com/demo/ |

The viewer parameters are also read:

| | |
|---|---|
| collection | InspiredLabs/ |
| A logical abstract collection of objects that can | TheArchWhole |
| be considered rooms, properties, or buildings | |
| location | loclobby00 |
| This is the unique name identifier for a bubble, | |
| which generally indicates as a prepend the | |
| physical origins of where the bubble was taken | |
| in the building | |
| bubble | Day |
| This is the term for a sequence of photographs | |
| taken at a single location - the exact center of the | |
| camera lens around which the camera is motor | |
| driven. Typically, this could be where the tripod | |
| is placed, or the media capture equipment is | |
| placed | |
| yaw | 0 |
| Refers to the Yaw of the bubble orientation from | |
| the original direction the physical picture was | |
| taken. To be precise this ‘original direction’ is | |
| calibrated within our production process to a | |
| floor plan ‘defined’ north about which a Yaw of | |
| all bubbles can be calculated | |
| pitch | 0 |
| (As above from Yaw) | |
| fov | 60 |
| The angle of view (for some reason almost | |
| always called “field of view” in 3d rendering). | |
| This controls how “zoomed in” the view is. A | |
| small fov means that we are zoomed in, a large | |
| fov means zoomed out. 60 degrees, as used here, | |
| is a fairly standard value. | |
| bookmarkDescription | This is the premier |
| The descriptive text that is added to the | hotel. |
| bookmark when such an option exists. For | |
| example, when the user uses the “Facebook” | |
| option for bookmarking, this description will be | |
| automatically attached. | |
| bookmarkUrlPrefix | http:// |
| This is the URL prefix to use when constructing | api.inspiredlabs.com/ |
| the bookmark URL. In the case of metadata | r/53129? |
| augmentation - which is the case here - it is for | |
| the InspiredLabs central server. With respect to | |
| this patent, the redirect parameters are collected | |
| from this server, and any information pertaining | |
| to a users movement through bubbles will be | |
| updated to this server | |
| bookmarkUrlTitle | TheArch London |
| The title for the bookmark, when applicable. or | |
| example, when the user uses the “Facebook” | |
| option for bookmarking, this title will be | |
| automatically inserted. | |

In order to integrate with the viewer, the clientAccount and object parameters are combined into a project viewer parameter by concatenating them with a slash separator and appending a “/main” literal:

| | |
|---|---|
| project | Rafi/The-Arch/main |

This is part of the viewer API. This is the way that a property id is passed to the viewer, and the reason it is done in such a roundabout way is that it is easier to store the property id as a client account/object pair in the database, but pass it in as a full project id to the viewer.

Rendering the Metadata Page

When rendering the Metadata Page, we must not just use the information in the EmbedSettings record, but also the viewer parameters in the bookmark URL. For example, if the user has bookmarked a certain location in the building and shares that bookmark, the in-feed viewer should start at that location. We do this by taking the viewer parameters from the bookmark URL and letting them override the corresponding viewer parameters in the EmbedSettings record.

In the sample bookmark URL, these are the key-value pairs following the question mark:

http://api.inspiredlabs.com/r/53129?collection=InspiredLabs/
TheArchWhole&project=Rafi/The-Arch/
main&location=loclobby14&bubble=day&yaw=0&pitch=0&fov=60

In a more readable form, they are:

| collection | InspiredLabs/TheArchWhole |
|---|---|
| project | Rafi/The-Arch/main |
| Location | loclobby14 |
| bubble | Day |
| yaw | 60 |
| pitch | 0 |
| fov | 60 |

We now do two things with these: First, they are appended unchanged to the target URL, ensuring that the bookmark parameters get passed all the way to the embedding page:

http://inspiredlabs.com/demo?collection=InspiredLabs/
TheArchWhole&project=Rafi/The-Arch/
main&location=loclobby14&bubble=day&yaw=0&pitch=0&fov=60

Second, they override the corresponding viewer parameters in the stored settings, creating the parameters for the in-feed viewer:

| | | |
|---|---|---|
| collection | InspiredLabs/TheArchWhole | From URL |
| project | Rafi/The-Arch/main | From URL |
| Location | loclobby14 | From URL |
| bubble | day | From URL |
| yaw | 60 | From URL |
| pitch | 0 | From URL |
| fov | 60 | From URL |
| bookmarkDescription | This is the premier hotel. | From |
| | | EmbedSettings |
| bookmarkUrlPrefix | http://api.inspiredlabs.com/r/ | From |
| | 53129? | EmbedSettings |
| bookmarkUrlTitle | TheArch London | From |
| | | EmbedSettings |

These parameters are then turned into:

1. An Adobe Flash URL for Facebook™ (and other Open Graph-supporting sites) to embed.

2. A HTML5 viewer URL, for devices that don't support Flash.

Both URLs are simply a prefix with the parameters appended in standard URL style, in a manner appropriate to the application. The Flash viewer URL is:

https://inspiredlabs-inpropertyview-cdn-3.s3.amazonaws.com/
viewer/inview_viewer.swf?il:collection=InspiredLabs/
TheArchWhole&il:project=Rafi/The-Arch/
main&il:location=loclobby14&il:bubble=day&il:yaw=0&il:pitch=0
&il:fov=60&il:bookmarkDescription=This%20is%20the%20premier%
20hotel.&il:bookmarkUrlPrefix=http://api.inspiredlabs.com/r/
53129%3F&il:bookmarkUrlTitle=TheArch%20London

The HTML5 url has the exact same parameter block, but with a different base URL2:

https://inpropertyview.appspot.com/smob?
il:collection=InspiredLabs/TheArchWhole&il:project=Rafi/The-Arch/
main&il:location=loclobby14&il:bubble=day&il:yaw=0&il:pitch=0
&il:fov=60&il:bookmarkDescription=This%20is%20the%20premier%
20hotel.&il:bookmarkUrlPrefix=http://api.inspiredlabs.com/r/
53129%3F&il:bookmarkUrlTitle=TheArch%20London

The “smob” in this URL is the Simple Mobile viewer. Other parameters, such as the bookmarkTitle and bookmarkDescription are used to fill in fields in the metadata page. The icon is retrieved from a standard location based on the new project, location, bubble, yaw and pitch parameters:

```
<html>
  <head>
    <title>TheArch London</title>
    <meta name=“description”
      content=“The premier hotel.”/>
    <meta property=“og:image”
      content=“Icon URL goes here . . . ”/>
    <meta property=“og:video”
      content=“Flash URL goes here . . . ”/>
    <meta property=“og:video:width”
      content=“360”/>
    <meta property=“og:video:height”
      content=“300”/>
    <meta property=“og:video:type”
      content=“application/x-shockwave-flash”/>
    <meta property=“og:video”
      content=“HTML 5 URL goes here . . . ” />
    <meta property=“og:video:type”
      content=“text/html” />
    <meta property=“og:title”
      content=“TheArch London”/>
    <meta property=“og:url”
      content=“This is the original request url.”/>
    <meta property=“og:type”
      content=“article”/>
    <meta property=“og:site_name”
      content=“”/>
    <meta property=“fb:app_id”
      content=“251293161571489”/>
    <script>
      function onLoad ( ) {
        // New target url goes here, with all
        // parameters appended.
        window.location.replace (
          “http://inspiredlabs.com/demo? . . . ”);
      }
    </script>
  </head>
  <body onload=“onLoad( );”>
  </body>
</html>
```

As can be seen, this example only includes a subset of all possible OpenGraph tags. In alternative embodiments the tags used are expanded to include:

Address and other location data

Contact information

Opening hours and other business data

These would be stored in the EmbedSettings record.

Other Bookmark URL Formats

The bookmark URL format used as an example is not required. As long as the key used to look up the embedding parameters are somehow included, and the viewer parameters are there, they two formats are functionally equivalent.

Sometimes it is easier to use a different format, for ease of implementation, higher robustness, better usability, etc. The example:

http://api.inspiredlabs.com/r/53129?collection=InspiredLabs/
TheArchWhole&project=Rafi/The-Arch/
main&location=loclobby14&bubble=day&yaw=0&pitch=0&fov=60

Would be written as below if it were created in a Facebook™ fan-page, to easier comply with Facebook™ requirements:

http://api.inspiredlabs.com/fbr/IL-Residential/247700281935340?
ref=ts&sk=app_191486910893656&embed=98001&app_data=collection
=InspiredLabs/TheArchWhole|project=Rafi/The-Arch/main|
location=loclobby14|bubble=day|yaw=0|pitch=0|fov=60

Here, the settings id is the bolded number, 247700281935340. The two representations are functionally equivalent, but the second is easier to implement and friendlier toward users.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

I claim:

1. A method of metadata augmentation of web pages comprising:
generating a URL relating to embedded media in a first web page, wherein the URL is for a metadata page separate to the first web page; and
providing the metadata page with metadata tags indicating viewing settings and/or parameters for the embedded media along with a redirect to the first web page;
whereby when the URL is shared on third party web page the third party web page will extract metadata from the metadata page and display the embedded media in accordance with the viewing settings and/or parameters, and a user following the URL will be redirected to the first web page.

2. A method as claimed in claim 1, wherein the redirect is itself augmented by metadata in order that the user is redirected to the first web page with the embedded media viewable in accordance with redirect viewing settings and/or parameters.

3. A method as claimed in claim 1, wherein the viewing settings and/or parameters comprise one or more of: a start point for interactive media, a video or a slideshow; a viewing angle, which may include pitch and/or yaw; a zoom level relating to an interactive image or video, or any other parameter that defines a location, position, viewpoint or the like in time or in space within the embedded media.

4. A method as claimed in claim 1, wherein the viewing settings and/or parameters are determined based on the parameters of the embedded media at the time the URL is generated.

5. A method as claimed in claim 1, wherein the redirect viewing settings and/or parameters are the same as the viewing settings and/or parameters defined in the metadata.

6. A method as claimed in claim 1, wherein the first web page comprises a media viewer for displaying the embedded media, and this viewer generates the URL.

7. A method as claimed in claim 6, wherein an entity associated with the media viewer carries out the step of providing the metadata page.

8. A method as claimed in claim 1, wherein the metadata page is provided with metadata tags from a metadata database.

9. A method as claimed in claim 1, wherein the redirect is a JavaScript™ redirect.

10. A method as claimed in claim 1, including user-agent detection by the metadata web page, whereby the third party web page is presented with the metadata tags and the user is presented with the redirect.

11. A metadata augmentation apparatus for web pages, the apparatus comprising:
a URL generator for generating a URL relating to embedded media in a first web page, wherein the URL is for a metadata page separate to the first web page; and
a metadata page generator for providing the metadata page, the metadata page including with metadata tags indicating viewing settings and/or parameters for the embedded media along with a redirect to the first web page;
whereby when the URL is shared on third party web page the third party web page will extract metadata from the metadata page and display the embedded media in accordance with the viewing settings and/or parameters, and a user following the URL will be redirected to the first web page.

12. An apparatus as claimed in claim 11, comprising a viewer for displaying the embedded media, wherein this viewer is the URL generator.

13. An apparatus as claimed in claim 11, including a metadata database.

14. A computer program product comprising instructions that when executed on a data processing device will configure the device to carry out a method of metadata augmentation of web pages as claimed in claim 1.
